(19) United States
(12) Patent Application Publication
(10) Pub. No.: US 2010/0161179 A1
(43) Pub. Date: Jun. 24, 2010

(54) INTEGRATED DEAD RECKONING AND GNSS/INS POSITIONING

(76) Inventors: John A. McClure, Scottsdale, AZ (US); Aaron C. Stichter, Scottsdale, AZ (US)

Correspondence Address: LAW OFFICE OF MARK BROWN, LLC, 4700 BELLEVIEW SUITE 210, KANSAS CITY, MO, 64112, US

(21) Appl. No.: 12/341,844

(22) Filed: Dec. 22, 2008

(51) Int. Cl. G01C 21/12; B62D 6/00

(52) U.S. Cl. 701/41; 701/216; 701/1

(57) ABSTRACT

An integrated dead reckoning (DR) and GNSS/INS control system and method are provided for guiding, navigating and controlling vehicles and equipment. A controller generally prioritizes GNSS navigation when satellite signals are available. Upon signal interruption, DR guidance can be integrated with INS to continue autosteering and other automated functions. Exemplary applications include logistics operations where ships, cranes and stacked containers can block satellite signals.

### CROSS-REFERENCE TO RELATED APPLICATION

This application claims priority in U.S. Provisional Application No. 60/016,451, filed Dec. 22, 2007, which is incorporated herein by reference.

### BACKGROUND OF THE INVENTION

1. Field of the Invention

The present invention relates generally to integrated dead reckoning and GNSS positioning, and in particular to applications on cargo-handling logistics equipment.

2. Description of the Related Art

Global Navigation Satellite Systems (GNSS), such as the Global Positioning System (GPS), have significantly advanced navigation, machine control and related fields. Accuracy can be significantly improved through the use of differential techniques, which encompass a wide variety of GPS accuracy enhancements, collectively referred to as differential GPS (DGPS). Such systems accurately locate points on a universal coordinate system, which facilitates vehicle and equipment operations. For example, the logistics field includes cargo-handling whereby cargo of various shapes and sizes is loaded, unloaded, stacked and otherwise positioned in and on vehicles and facilities.

For several decades port operations have been converting to containerized cargo operations. The cargo containers have standardized lengths in different sizes, such as 20, 40 and 45 feet. Container ships account for a large portion of cargo shipping, and are accommodated by automated containerized ports with massive container-handling gantry cranes for loading and offloading operations. Ashore, the containers can be stacked five-high while awaiting ground transport or loading onto container ships. Such vertical storage at containerized ports can create problems with using conventional GNSS guidance because the ships, container stacks and equipment often block the satellite signals. For example, dockside forklifts and gantries often operate within stacks of containers, which can create relatively deep “valleys” from which satellite acquisition and signal lock are often compromised. GNSS navigation requires line-of-site access to the signals of at least four satellites in the constellation. An interruption of such access causes signal loss whereby accurate positioning can no longer be based on GNSS along. Previous systems have used gyroscope-based inertial guidance augmentation for “coasting” until enough GNSS signals are reacquired. However, cargo container handling and other logistics operations may require greater accuracy and more consistency than have previously been available.

In order to accommodate the position locating needs of the logistics industry generally, and cargo container handling specifically, a relatively high degree of accuracy may be consistently needed. Continuous knowledge of the location of individual containers from being offloaded from the ship by crane, being translocated around the dock area in stacking locations and finally leaving the secured dock area by rail or truck is now a requirement, for security. Positioning input is thus needed from GNSS, inertial (gyroscopic) guidance and dead reckoning sources to match with the container ID at all times.

Heretofore there has not been available an integrated dead reckoning and GNSS positioning system and method with the advantages and features of the present invention.

### SUMMARY OF THE INVENTION

In the practice of the present invention, positioning is accomplished by receiving GNSS location signals, calculating latitude and longitude scale factors, integrating with inertial input from gyroscopes and integrating with dead reckoning input from vehicle wheel sensors. Operating parameters, such as vehicle motion, direction and speed, are sensed and used for selecting and integrating the appropriate positioning input(s) for guidance and other operations. Optical recognition and RFID methods can be utilized in connection with storage and retrieval operations in logistics applications when coupled with this new extended positioning capability.

### BRIEF DESCRIPTION OF THE DRAWINGS

FIG. 1 is a block diagram of a dead reckoning, inertial and GNSS-based positioning system embodying an aspect of the present invention.

FIG. 2 is a plan view of a cargo container port operation involving a container ship, a gantry crane and transport vehicles, which utilizes the positioning system of the present invention in loading and unloading operations. FIG. 3 is an end elevational view of a gantry crane positioned over a stack of cargo containers.

FIG. 4 is a side elevational view of a container forklift.

FIG. 5 is a flow diagram of a positioning method embodying an aspect of the present invention.

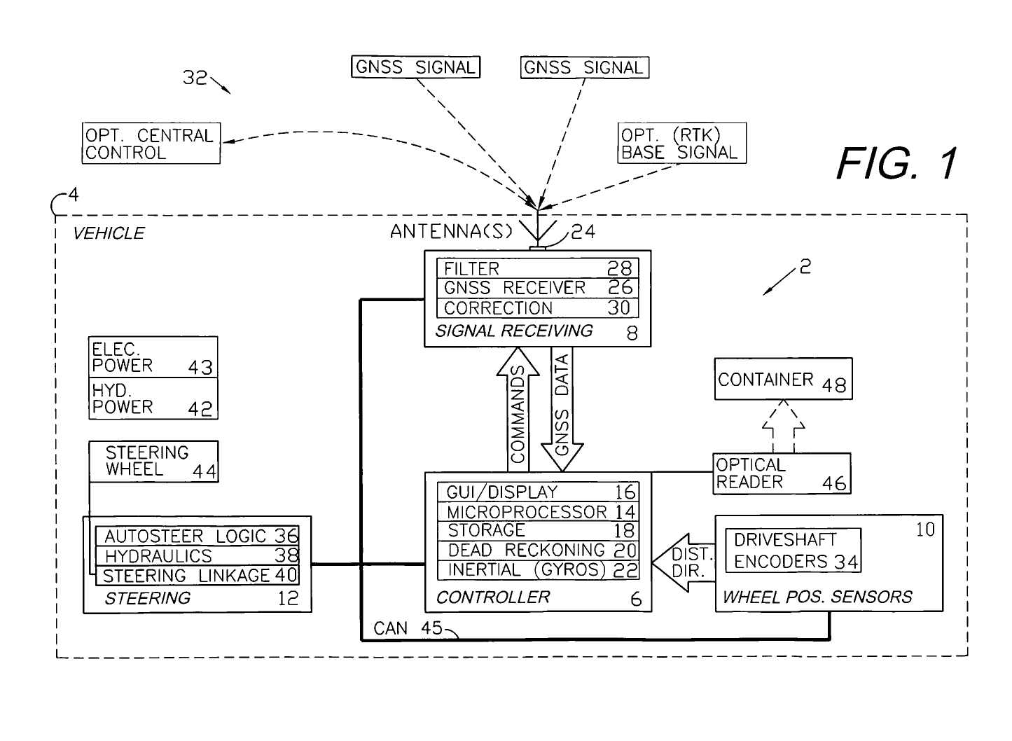

### DETAILED DESCRIPTION OF THE PREFERRED EMBODIMENTS

### I. Introduction and Environment

As required, detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

Certain terminology will be used in the following description for convenience in reference only and will not be limiting. For example, up, down, front, back, right and left refer to the invention as oriented in the view being referred to. The words “inwardly” and “outwardly” refer to directions toward and away from, respectively, the geometric center of the embodiment being described and designated parts thereof. Global navigation satellite systems (GNSS) are broadly defined to include GPS (U.S.), Galileo (proposed), GLONASS (Russia), Beidou (China), Compass (proposed), IRNSS (India, proposed), QZSS (Japan, proposed) and other current and future positioning technology using signals from satellites, with or without augmentation from terrestrial sources. Inertial navigation systems (INS) include gyroscopic (gyro) sensors, accelerometers and similar technologies for providing output corresponding to the inertia of moving components in all axes, i.e. through six degrees of freedom (positive and negative directions along transverse X, longitudinal Y and vertical Z axes). Yaw, pitch and roll refer to moving component rotation about the Z, X and Y axes respectively. Said terminology will include the words specifically mentioned, derivatives thereof and words of similar meaning.

### II. Preferred Embodiment System 2.

Referring to the drawings in more detail, the reference numeral 2 generally designates a system embodying an aspect of the present invention, which generally includes a vehicle 4, a controller 6, a GNSS signal-receiving input subsystem 8, a wheel position input subsystem 10 and a vehicle steering subsystem 12. Without limitation on the generality of useful applications of the control system 2, the vehicle 4 can be adapted for logistics operations such as storage, retrieval, loading and unloading in conjunction with transportation operations. The controller 6 includes a microprocessor 14, a graphical user interface (GUI) 16 and data storage 18, all of which can be provided by a general-purpose computer or a special-purpose programmable logic controller (PLC). A dead reckoning (DR) function is provided at 20 and an INS (gyroscopic) function is provided at 22.

The GNSS input subsystem 8 can be mounted remotely from the controller 6, for example on an elevated mast or other structural component of the vehicle 4. An example of a suitable GNSS input subsystem is a Crescent A100 Smart Antenna, which is available from Hemisphere GPS LLC of Calgary, Alberta, Canada. The GNSS input subsystem 8 includes one or more antennas 24 connected to a receiver 26 via a filter 28 and a correction function 30. GNSS signals are received from satellites, an optional central control and an optional real-time kinematic (RTK) source, collectively referred to as a GNSS source or constellation 32. GNSS positioning data is transmitted from the GNSS input subsystem 8 to the controller 6, and commands from the controller 6 are received by the GNSS input subsystem 8.

The wheel positioning input subsystem 10 utilizes drive shaft encoders 34 for producing an output to the controller 6 corresponding to distance and direction of vehicle travel, providing the necessary inputs for a DR operating mode. The steering subsystem 12 includes autosteer logic 36, hydraulics 38 and steering linkage 40. Examples of autosteering systems are shown in U.S. Pat. No. 7,142,956, which is incorporated herein by reference. An hydraulic power source 42 drives the steering hydraulics 38 and a steering wheel 44 provides manual steering input. Electrical power from a source 46 is distributed to the system 2 components and signal distribution is provided via a controller area network (CAN) 45, or via some other suitable hardwired or wireless (e.g. optical, RF, etc.) distribution. An optional optical character reader 46 provides input to the controller 6, which can comprise data from barcode and other labels on containers 48.

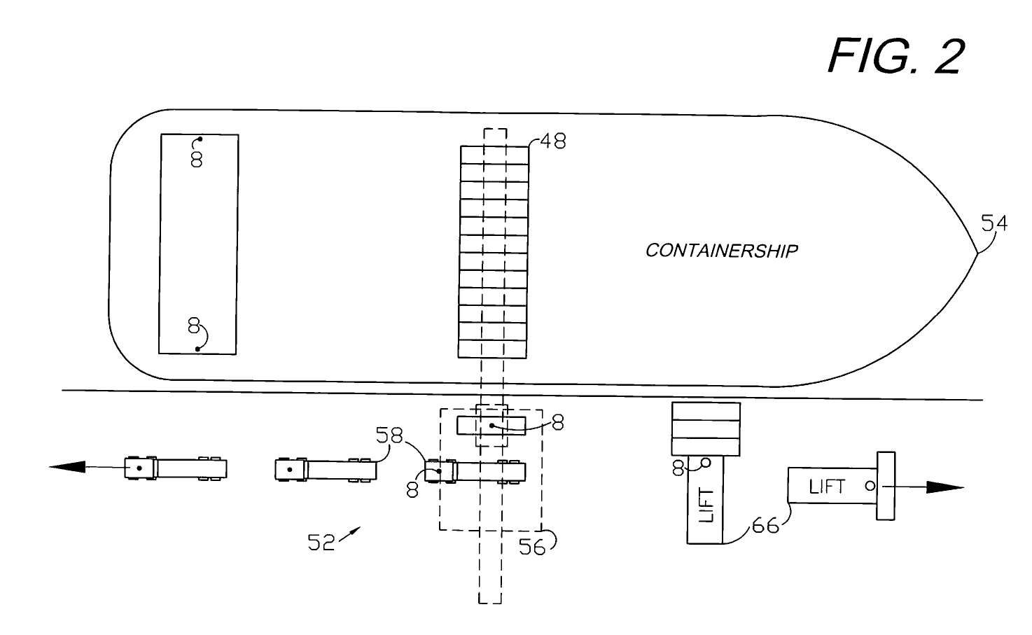

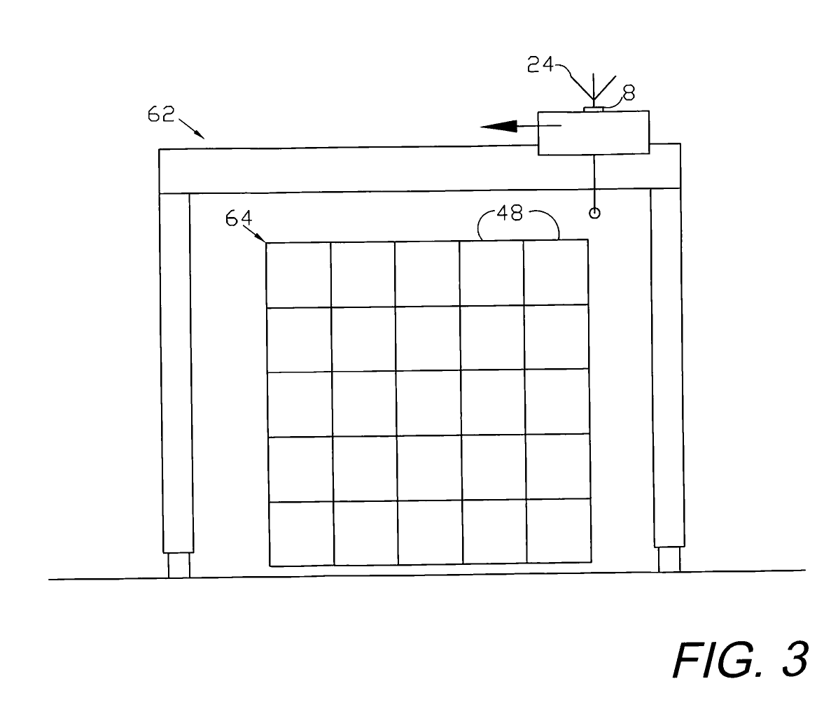

FIG. 2 shows an application of the system 2 in a containerized cargo operation 52 wherein a container ship 54 configured for transporting stacks of cargo containers 48. A gantry crane 56 is mounted dockside for loading and unloading an adjacent ship 54 from or onto land vehicles, such as tractor-trailer trucks 58. The gantry crane 56 can be equipped with the system 2 for controlling its operation. For example, the GNSS input subsystem 8 can be mounted on the highest point of the crane structure for maximum satellite signal reception by permitting the antenna 24 to “see” as many satellites as possible. The ship 54 can also be equipped with GNSS capability, including antennas 24 located on either side of the bridge for determining ship attitude and location.

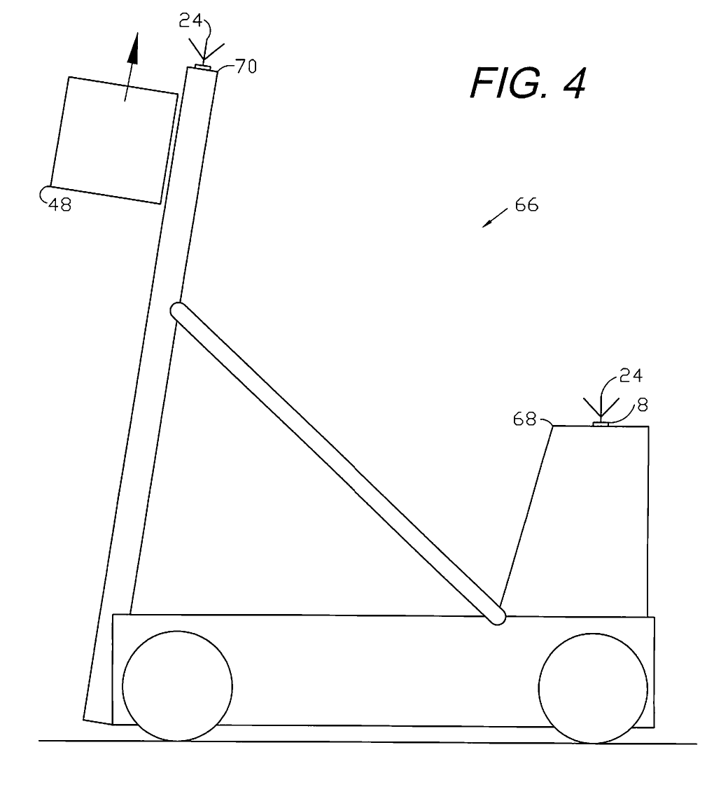

FIG. 3 shows a mobile, self-propelled crane 62 with the system 2 mounted on an upper part of its structure for maximum antenna 24 exposure. A five-high stack 64 of containers 48 is located in position for the crane 62 to straddle for picking up and depositing containers 48. FIG. 4 shows a forklift 66 with the system 2 mounted thereon with antennas 24 and/or receivers mounted on a forklift cab 68 and/or at the top of its mast 70, which is the highest point of the forklift 66. The forklift 66 is designed to lift containers 48 sufficiently high to form stacks, such as 64, of a desired height.

### III. Integrated Dead Reckoning and GNSS/INS Positioning Method.

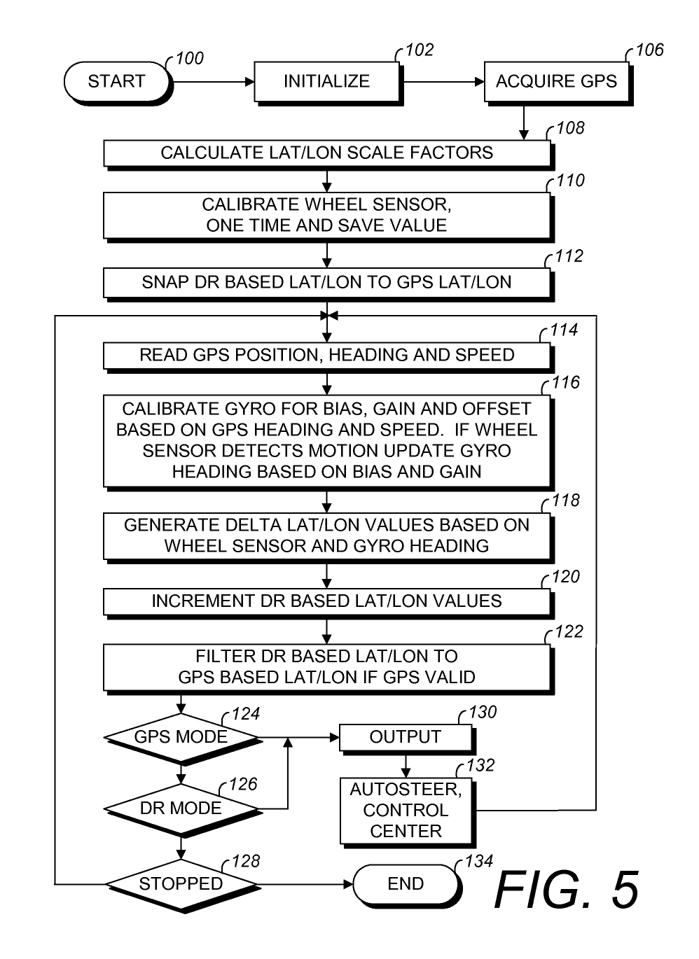

FIG. 5 is a flowchart for a method embodying an aspect of the present invention, which commences at a start 100 and proceeds to an initialization step 102 whereat various operating parameters can be programmed and preset. GNSS (e.g., GPS) signals are acquired at the 106, enabling calculation of latitude and longitude scale factors at 108. With the system 2 in motion, the wheel sensors are calibrated one time and the values saved at 110. A snap dead reckoning (DR) based latitude and longitude (lat/lon) to GPS (lat/lon) step occurs at 112, i.e. during normal operation with the GNSS input subsystem 8 functional. GPS position, heading and speed are calculated at 114 and INS (gyroscopic) calibration for bias, gain and offset based on GPS heading and speed occurs at 116. If the wheel sensor 10 detects motion, the gyro heading is updated based on bias and gain. Delta lat/lon values are generated based on wheel sensor and gyro heading inputs at 118. DR is incremented based on lat/lon values at 120. Filtered DR based lat/lon to GPS based lat/lon occurs at 122 if GPS is valid. At decision box 124 an affirmative decision indicating GNSS (GPS) mode operating leads to an output at 130 for input to an autosteer control center at 132. The method then proceeds to the read GPS position, heading and speed step at 114. As long as the GNSS mode is considered operational, it has an adequate number of tracked satellites and its standard deviation of the solution and geometric dilution of precision and age of differential is low, it can provide primary guidance until the procedure ends at 134. A negative decision at 124 leads to a dead reckoning (DR) mode decision box 126, with an affirmative decision leading to the output step 118 and the autosteer control center at 132. If the DR input subsystem 10 is not functioning (negative decision at 126), determined by estimated age since last GPS based calibration, the system 2 determines if the vehicle has stopped at 128, from which an affirmative decision leads to an end at 134.

The operation allows a continuous tracking of the position associated with a container 48. Depending on the antenna location on the moving vehicle and its heading, an offset from the “new” position can be generated and assigned to the container 48. On picking up or dropping off the container 48 the container ID information and the container location can be sent to the Central Control station where the data base of all container locations can continuously be updated. If the equipment is not stopped, the method loops back to step 114 for operation in an INS mode until GNSS or DR modes are reacquired.

The DR mode can maintain relatively accurate guidance during interruptions of GNSS signals, for example when the equipment is located between container stacks or adjacent ships and dockside equipment blocking the satellite signals. Preferably GNSS signals will be reacquired after a short DR “coasting” mode of operation because DR accuracy tends to degrade until “corrected” by a GNSS location fix upon satellite signal reacquisition. The sequence of the method steps, and the steps themselves, can vary according to particular applications of the system 2 and the equipment on which it is mounted.

### IV. Additional Features and Functionalities.

The following include additional features and functionalities, which can be incorporated in the system 2 and its operation:
Updating INS/gyro input subsystem 22.
Calibrating wheel sensors/encoders 34 during a calibration test. Typically: start calibration; drive straight for approximately 100 meters; and stop calibration.
Calculating latitude (lat)/longitude (lon) scale factors soon after first valid GNSS acquisition.
Calculating internal DR lat/lon values. These are based on integrated average wheel sensor and gyro heading and biased towards valid GNSS lat/lon values when available.
Determine if need to stop updating gyro heading when stopped in DR mode (e.g., no pulses in specified time interval) or below speed cutoff when in GNSS mode, e.g. 1 mph.
Flips in and out of GPS and DR modes depending on criteria TBD, potentially GPS stdev>1 m, sats<6, displays age incremented since value in last GPS mode.
Outputs GGA with differential or DR flags (1 GPS, 2 DIF, 4 RTK, 6 DR) and VTG at 5 Hz
I/O requirements. 2 pulse streams, serial/power to A100, serial to SATTEL Messenger
Will operate with use of SBAS, beacon with the eDrive box, additionally L Dif, and RTK for the next generation product.
For LDif/RTK correctors can be accepted via the Messenger port and sent out to the A100.
Programmable GAP application, saving, loading, downloading of GAP parameters, output of debug data as required.

It is to be understood that the invention can be embodied in various forms, and is not to be limited to the examples discussed above. Other components can be utilized with the present invention.

Having thus described the invention, what is claimed as new and desired to be secured by Letters Patent is:

1. A method of storing, positioning and retrieving containers in a containerized cargo handling facility, which method includes the steps of:
providing the vehicle with a GNSS receiver;
providing the vehicle with a processor connected to the GNSS receiver;
providing the vehicle with a dead reckoning subsystem connected to the processor;
providing the dead reckoning subsystem with a dead reckoning sensor connected to the vehicle and the processor;
providing GNSS positioning signal inputs from said receiver to said processor;
providing dead reckoning signals corresponding to movement of said vehicle from said dead reckoning sensor to said processor;
integrating in said processor GNSS positioning signals and dead reckoning signals; and
guiding said vehicle utilizing said integrated signals.

2. The method of claim 1, which includes the additional steps of:
equipping said vehicle with a wheel position sensor including a drive shaft encoder; and
providing distance and direction inputs to said processor from said wheel position sensor.

3. The method of claim 2, which includes the additional steps of:
equipping said vehicle with an inertial navigation system (INS) including a gyroscope and/or an accelerometer.

4. The method of claim 2, which includes the additional steps of:
calibrating the dead reckoning subsystem with GNSS positioning inputs.

5. The method of claim 3, which includes the additional steps of:
calibrating the INS with GNSS positioning inputs.

6. The method of claim 1, which includes the additional steps of:
providing said vehicle with an optical reader;
connecting said optical reader to said processor;
providing information on said containers visible to said optical reader;
scanning said container information with said optical reader;
providing input signals to said processor from said optical reader corresponding to information scanned by said optical reader; and
controlling said vehicle using said container information.

7. The method of claim 1, which includes the additional step of:
equipping said vehicle with an autosteer subsystem connected to said processor; and
automatically steering said vehicle with control signals from said processor.

8. The method of claim 1, which includes the additional steps of:
calculating with GNSS latitude and longitude scale factors;
snapping a vehicle position to a GNSS-derived latitude and longitude; and
generating latitude and longitude value changes based on heading and distance values detected by said dead reckoning subsystem and said INS.

9. The method of claim 1 wherein said vehicle comprises a forklift with a cab and a mast connected to said cab, which method includes the additional steps of:
providing a first GNSS antenna mounted on said cab;
providing a second GNSS antenna mounted on said mast; and
providing GNSS measurements to said processor from said first and second GNSS antennas; and
determining an attitude of said vehicle from said the GNSS measurements.

10. The method of claim 1, which includes the additional steps of:
providing said facility with a waterfront wharf for marine vessels;
providing said facility with road and/or railroad facilities for access by trucks and/or trains;
providing said facility with a gantry crane for transferring cargo containers to and from marine vessels and trucks;
providing said facility with a forklift for transferring and stacking cargo containers in staging areas; and
equipping and controlling operation of said marine vessels, trucks and/or trains, gantry crane and forklift with respective GNSS systems.

11. A method of storing, positioning and retrieving containers in a containerized cargo handling facility with stacks of containers accessible via aisles formed between said container stacks, which method includes the steps of:
providing a vehicle chosen from among the group comprising: forklift; gantry crane; and
truck configured for transporting cargo containers;
providing said vehicle with a GNSS subsystem including a GNSS receiver;
providing the vehicle with a processor connected to the GNSS receiver;
providing the vehicle with a dead reckoning subsystem including a wheel sensor connected to a vehicle wheel;
connecting the dead reckoning subsystem to the processor;
providing an inertial navigation system (INS) connected to the processor;
providing the dead reckoning subsystem with a dead reckoning sensor connected to the vehicle and the processor;
providing GNSS positioning signal inputs from said receiver to said processor;
providing dead reckoning signals corresponding to movement of said vehicle to said processor;
integrating in said processor GNSS positioning signals and dead reckoning signals; and
guiding said vehicle utilizing said integrated signals.

12. An integrated dead reckoning and GNSS method of positioning a vehicle, which method comprises the steps
providing the vehicle with a GNSS receiver;
providing the vehicle with a processor connected to the GNSS receiver;
providing the vehicle with a dead reckoning subsystem;
providing the dead reckoning subsystem with a dead reckoning sensor connected to the vehicle and the processor;
providing GNSS positioning signal inputs from said receiver to said processor;
providing dead reckoning signals corresponding to movement of said vehicle to said processor;
integrating in said processor GNSS positioning signals and dead reckoning signals; and
guiding said vehicle utilizing said integrated signals.

13. The method of claim 12, which includes the additional steps of:
equipping said vehicle with a wheel position sensor including a drive shaft encoder; and
providing distance and direction inputs to said processor from said wheel position sensor.

14. The method of claim 13, which includes the additional steps of:
equipping said vehicle with an inertial navigation system (INS) including a gyroscope and/or an accelerometer.

15. The method of claim 13, which includes the additional steps of:
calibrating the dead reckoning subsystem with GNSS positioning inputs.

16. The method of claim 14, which includes the additional steps of:
calibrating the INS with GNSS positioning inputs.

17. The method of claim 12, which includes the additional steps of:
providing said vehicle with an optical reader;
connecting said optical reader to said processor; and
providing input signals to said processor from said optical reader corresponding to information scanned by said optical reader.

18. The method of claim 12, which includes the additional step of:
equipping said vehicle with an autosteer subsystem connected to said processor; and
automatically steering said vehicle with control signals from said processor.

19. The method of claim 12, which includes the additional steps of:
calculating with GNSS latitude and longitude scale factors;
snapping a vehicle position to a GNSS-derived latitude and longitude; and
generating latitude and longitude value changes based on heading and distance phase detected by said dead reckoning subsystem and said INS.

20. A system for storing, positioning and retrieving containers in a containerized cargo handling facility, which system includes:
a GNSS receiver;
a processor connected to the GNSS receiver;
a dead reckoning subsystem connected to the processor;
the dead reckoning subsystem including a dead reckoning sensor connected to the vehicle and the processor;
GNSS positioning signal inputs from said receiver to said processor;
dead reckoning signals corresponding to movement of said vehicle from said dead reckoning sensor to said processor;
said processor being configured to integrate GNSS positioning signals and dead reckoning signals; and
said processor being configured to guide to said vehicle utilizing said integrated signals.
